(19) United States
(12) Patent Application Publication
(10) Pub. No.: US 2014/0316960 A1
(43) Pub. Date: Oct. 23, 2014

(54) MERCHANT BANK TOOL

(71) Applicant: BANK OF AMERICA CORPORATION, Charlotte, NC (US)

(72) Inventors: Murali Katepally, Hyderabad (IN); Reema Verma, Raipur (IN); Ananya Bhattacharyya, Howrah (IN); Ravuri Radha M Y Krishna, Hyderabad (IN)

(73) Assignee: Bank of America Corporation, Charlotte, NC (US)

(21) Appl. No.: 13/868,364

(22) Filed: Apr. 23, 2013

(51) Int. Cl. G06Q 40/00

(52) U.S. Cl. CPC G06Q 40/02
USPC 705/35

(57) ABSTRACT

Apparatus for identifying a disputed merchant bank is provided. The apparatus may comprise a receiver configured to receive transactional data, claim data, and disputed merchant data from one or more databases. The apparatus may also include a processor configured to calculate metric values for each of a plurality of merchant banks. The processor may be further configured to profile a distribution of each of the metrics into two or more bins and to assign a risk score to each bin. The processor may also be configured to calculate an aggregated risk score for each of the plurality of merchant banks by summing a risk score for each metric value associated with the merchant bank, the risk score corresponding to the risk score of the bin into which the metric value is distributed.

### FIELD OF TECHNOLOGY

The invention relates to a tool for use in analyzing transaction behavior. Specifically, the invention relates to a tool for analyzing one or more debit card transactions, credit card transactions and automated clearing house transactions.

### BACKGROUND OF THE DISCLOSURE

Many merchants provide their customers with a credit card payment option. To provide a credit card payment option, a merchant partners up with a bank, referred to alternately hereinafter as a “merchant bank.” The merchant bank processes credit card payments on behalf of the merchant.

Processing of a customer's credit card payment may proceed as follows. A customer initiates a payment for a purchase amount by swiping his credit card at a point of sale terminal, or by inputting credit card information in an online payment webpage. A request for funds is subsequently transmitted from the point of sale terminal, or from the webpage, to a merchant bank. Alternatively, the request for funds may be transmitted from the merchant to a merchant bank via a Third Party Agent (“TPA”).

Subsequent to the receipt of the request for funds, the merchant bank transmits the request to a transaction processing network, such as Visa™, MasterCard™ or American Express™. The transaction processing network transmits the request for funds to a bank that has issued credit to the customer, referred to, in the alternative, hereinafter as an “issuing bank.”

The issuing bank determines if the customer has sufficient credit to cover the purchase amount. If the customer has sufficient credit, the issuing bank transmits an authorization message to the merchant bank via the transaction processing network. The merchant bank transmits the authorization message to the merchant.

Typically, a relationship between a merchant bank and an issuing bank is a source of revenue for the issuing bank. However, the relationship may become unprofitable for the issuing bank. This may be the result of a large number of customers disputing payments authorized by the issuing bank on behalf of the merchant bank, also known as “claims.”

Claims are undesirable for an issuing bank. This is because large amounts of time and resources are necessary to process the claims. Additionally, a large number of claims are undesirable for an issuing bank because they may open the issuing bank to fines and/or sanctions from various governmental bodies.

It would be desirable, therefore, for an issuing bank to identify a merchant bank that has a large number of claims filed against the merchant bank's transactions. This would be desirable at least because identifying merchant banks with high numbers of claims may assist an issuing bank in taking one or more forms of action to reduce processing expenses and potential liabilities.

### SUMMARY OF THE DISCLOSURE

Systems and methods are provided for identifying a disputed merchant bank. The disputed merchant bank may be identified using a merchant bank tool. The merchant bank tool may receive transactional data, claim data, and disputed merchant data from one or more databases. The merchant bank tool may use the data to calculate, for each of a plurality of merchant banks, a metric value for each of a plurality of metrics. The merchant bank tool may profile a distribution of each of the metrics into two or more buckets. The merchant bank tool may assign a risk score to each of the buckets.

The merchant bank tool may then assign risk scores to the merchant banks based on which buckets their metric values fall into. The merchant bank tool may then weigh and sum the risk scores assigned to each merchant bank to compute a final risk score. The merchant bank tool may rank the final risk scores in descending order to identify disputed merchant banks included in the plurality of merchant banks.

Systems and methods are also provided for an article of manufacture comprising a non-transitory computer usable medium having computer readable program code embodied therein, the code when executed by a processor causes a computer to compute metric values for merchant banks. The computer readable program code in the article may comprise computer readable program code for causing the computer to receive transactional data including a plurality of transactions processed by merchant banks during a predetermined time period, claim data including a plurality of claims filed against one or more of the plurality of transactions, and disputed merchant data including one or more identifiers identifying disputed merchants. The disputed merchants may be merchants with a claim rate that has surpassed a predetermined threshold.

The computer readable program code may also cause the computer to identify a plurality of merchant banks. Each of the plurality of merchant banks may be merchant banks that electronically processed one or more transactions on behalf of one or more disputed merchants during the predetermined time period.

The computer readable program code may additionally cause the computer to calculate, for each of the plurality of merchant banks, a metric value for each of a plurality of metrics based at least in part on the transactional data, the claim data and the disputed merchant data.

The computer readable program code may further cause the computer, for each metric, to divide a distribution of metric values into a plurality of bins. Each bin may be associated with a portion of the data distribution. The computer readable program code may further cause the computer to assign a risk score to each of the plurality of bins.

In some embodiments, the computer readable program code may also calculate an aggregated risk score for each merchant bank. In some embodiments, the aggregated risk score for each merchant bank may be calculated by the computer readable program code by summing a risk score for each metric value associated with the merchant bank, the risk score corresponding to the risk score of the bin into which the metric value is distributed.

In some embodiments, the computer readable program code may also calculate the aggregated risk score based on the equation Σᵢ₌₁ⁿSi*wi, where i is one of the plurality of metrics, Si is a risk score assigned to a merchant for metric i, and wi is a weight value associated with metric i.

In some embodiments, the computer readable program code may calculate a metric value for a merchant bank by accessing and summing a total number of claims filed against transactions processed by the merchant bank during the predetermined time period. In some embodiments, the computer readable program code may calculate a metric value for a merchant bank by calculating an average change in an amount of claims filed against transactions processed by the merchant bank during the predetermined time period.

In some embodiments, the computer readable program code may calculate a metric value for a merchant bank by dividing a total number of claims filed against transactions processed by the merchant bank during the predetermined time period by a total number of transactions processed by the merchant bank during the predetermined time period.

In some embodiments, the computer readable program code may cause a computer to electronically transmit an email message to at least a portion of the plurality of merchant banks, the email message detailing remedial action that must be taken by the merchant bank in order to sustain a business relationship with an issuing bank.

Systems and methods are also provided for apparatus for computing metric values for merchant banks. The apparatus may include a receiver configured to receive transactional data including a plurality of transactions processed by merchant banks during a predetermined time period, claim data including a plurality of claims filed against one or more of the plurality of transactions, and disputed merchant data including one or more identifiers identifying disputed merchants. The disputed merchants may be merchants with a claim rate that has surpassed a predetermined threshold.

The apparatus may also include a processor configured to identify a plurality of merchant banks, each of the plurality of merchant banks being merchant banks that electronically processed one or more transactions on behalf of one or more disputed merchants during the predetermined time period

The processor may be further configured to calculate, for each of the plurality of merchant banks, a metric value for each of a plurality of metrics based at least in part on the transactional data, the claim data and the disputed merchant data. The processor may also be configured, for each metric, to divide a distribution of metric values into a plurality of bins, wherein each bin is associated with a portion of the data distribution. The processor may additionally be configured to assign a risk score to each of the plurality of bins.

In some embodiments, the processor may be configured to calculate an aggregated risk score for each merchant bank. In some embodiments, the processor may be configured to calculate the aggregated risk score for each merchant bank by summing a risk score for each metric value associated with the merchant bank, the risk score corresponding to the risk score of the bin into which the metric value is distributed. In some embodiments, the processor may be configured to calculate the aggregated risk score based on the equation Σᵢ₌₁ⁿSi*wi, where i is one of the plurality of metrics, Si is a risk score assigned to a merchant for metric i, and wi is a weight value associated with metric i.

In some embodiments, the processor may be configured to calculate a metric value for a merchant bank by accessing and summing a total number of claims filed against transactions processed by the merchant bank during the predetermined time period. In some embodiments, the processor may be configured to calculate a metric value for a merchant bank by calculating an average change in an amount of claims filed against transactions processed by the merchant bank during the predetermined time period.

In some embodiments the processor may be configured to calculate a metric value for a merchant bank by dividing a total number of claims filed against transactions processed by the merchant bank during the predetermined time period by a total number of transactions processed by the merchant bank during the predetermined time period.

In some embodiments the apparatus may also include a transmitter. The transmitter may be configured to electronically transmit an email message to a portion of the plurality of merchant banks with a final risk score equal to or greater than a predetermined threshold value, the email message detailing remedial action that must be taken by the merchant bank in order to sustain a business relationship with an issuing bank.

### BRIEF DESCRIPTION OF THE DRAWINGS

The objects and advantages of the invention will be apparent upon consideration of the following detailed description, taken in conjunction with the accompanying drawings, in which like reference characters refer to like parts throughout, and in which:

FIG. 1 shows apparatus that may be used in accordance with the systems and methods of the invention;

FIG. 2 shows a flow diagram of a process that may be used in accordance with the invention;

FIG. 3 shows a graphical display that may be output by apparatus in accordance with the invention;

FIG. 4 shows another graphical display that may be output by apparatus in accordance with the invention;

FIG. 5 shows yet another graphical display that may be output by apparatus in accordance with the invention;

FIG. 6 shows yet another graphical display that may be output by apparatus in accordance with the invention;

FIG. 7 shows yet another graphical display that may be output by apparatus in accordance with the invention; and

FIG. 8 shows yet another graphical display that may be output by apparatus in accordance with the invention.

### DETAILED DESCRIPTION OF THE DISCLOSURE

The systems and methods of the invention may include receiving merchant bank data relating to one or more merchant banks and/or merchant data relating to one or more merchants. The systems and methods of the invention may also include a merchant bank tool. The merchant bank tool may compute one or more metric values for a plurality of merchant banks based on the received data. The plurality of merchant banks may include some or all of the merchant banks included in the received data. The merchant bank tool may also assign a risk score to each of the plurality of merchant banks based at least in part on the metric values.

The merchant bank tool may be used by an issuing bank, a third party, a merchant bank, or any other business or association to analyze merchant bank behavior. An exemplary usage of the merchant bank tool includes using the merchant bank tool as part of an issuing bank's Customer Due Diligence (CDD) process prior to acquisition of a merchant bank and/or as part of an ongoing CDD of an acquired merchant bank.

The merchant bank tool may be in electronic communication with one or more databases. The databases may store merchant bank data and/or merchant data. A merchant bank may be an acquirer bank, an Originating Depository Financial Institution (“ODFI”), or any other bank or institution that processes transactions on behalf of one or more merchants.

Exemplary databases include a transactional data warehouse, a spend data warehouse, a disputed merchant claim data warehouse and a merchant bank data warehouse.

Transactional data warehouse may store payment information. Payment information may include information relating to a plurality of payments, such as debit card transactions, credit card transactions, and/or ACH transactions. The payments may be payments executed by one or more merchants. The payment information may additionally include payment processing information. The payment processing information may relate to the processing of payments by one or more third party agents information and/or one or more merchant banks.

Spend data warehouse may store transaction information. Transaction information may include information relating to one or more features of payment transactions executed by one or more merchants. Exemplary features of payment transactions include whether each payment transactions was an online/offline transaction, the amount of the payment transaction, the date of the transaction, customer information identifying an account number of a customer who executed the payment transaction and/or an MCC assigned to the transaction.

Disputed merchant claim data warehouse may store claim level information. Claim level information may include information detailing one or more characteristics of customer claims filed against transactions executed by one or more merchants and processed by merchant banks. Exemplary claim level information may include whether a claim is a fraud-based claim or a non-fraud claim, the date the claim was filed, the amount of the claim and/or the current status of the claim.

Merchant bank data warehouse may store information relating to one or more merchant banks. Merchant bank information may include, for one or more merchant banks, the name of the merchant banks, an acceptor ID associated with each merchant bank and/or the address of the merchant banks.

The merchant bank tool may receive data from the one or more databases. The merchant bank tool may receive the data by transmitting a request to the database(s) for data. Alternatively, the database(s) may transmit data to the merchant bank tool at preferably predetermined, or at user-selected, time intervals.

Exemplary data received by the merchant bank tool may include transactional data, claim data, disputed merchant data, and/or any other suitable data. At least a portion of the data received by the merchant bank tool may include a time, date, and/or a merchant bank identifier. The transactional data, claim data, and disputed merchant data are described in greater detail below.

The data received by the merchant bank tool may relate to merchants and/or merchant banks. The data received by the merchant bank tool may be data generated during a predetermined time period, referred to alternatively hereinafter as “the predetermined time period.” The predetermined time period may be a day, a week, a month, two months, one year, a time period during which the merchant bank(s) have been in business and/or any other suitable time period.

In some embodiments, the plurality of merchant banks may be merchant banks that have engaged in business, during the predetermined time period or any other suitable time period, with one or more disputed merchants. In some embodiments, a merchant bank may be determined to be engaged in business with a merchant if the merchant bank processed one or more transactions executed by a merchant. In some embodiments, a merchant bank may be determined to be engaged in business with a merchant if the merchant bank has one or more established business relationships with the merchant.

For the purposes of the application, a disputed merchant may be a merchant with a merchant fraudulent claim ratio that is greater than or equal to a threshold value. Alternatively, a disputed merchant may be a merchant with a benchmarked merchant fraudulent claim ratio which is greater than or equal to a threshold value. Apparatus and methods for calculating a merchant fraudulent claim ratio and a benchmarked merchant fraudulent claim ratio is discussed in “Claim Rate Black Box,” U.S. patent application Ser. No. 13/628,303, filed Sep. 27, 2012, which is hereby incorporated by reference herein in its entirety.

### Transactional Data

The transactional data received by the merchant bank tool may include transactional data relating to transactions processed by merchant banks on behalf of merchants. The transactions may include transactions from one or more transaction channels. Transaction channels may include debit card transactions, credit card transactions and/or automated clearing house (“ACH”) transactions.

The transactional data received by the merchant bank tool may include transactions processed by a plurality of merchant banks during the predetermined time period. For example, the transactions may include a day's transactions, a week's transactions, a month's transactions, or transactions that occurred in any other predetermined time period.

In some embodiments, the merchant bank tool may align the predetermined time period with each transaction channel's regulatory and/or payment association's maximum claim timeframe. An exemplary predetermined time period for transaction data including debit card transactions and/or credit card transactions may be 60 days, 90 days, 91 days or up to one year. An exemplary predetermined time period for transaction data including ACH transactions may be up to one year.

In some embodiments, the transactional data may include a total number of transactions processed by each of a plurality of merchant banks daily, weekly, monthly, and/or during any other predetermined time period.

### Claim Data

Claim data received by the merchant bank tool may include a plurality of claims. Each of the plurality of claims may be a claim filed against a transaction processed, on behalf of a merchant, by a merchant bank during the predetermined time period. In some embodiments, claim data may include a total number of claims filed against a transaction processed by each merchant bank included in the plurality of merchant banks during one or more days, one or more weeks, one or more months, and/or any other suitable time period.

In some embodiments, claim data may include some or all claims filed against the transactions included in the transactional data received by the merchant bank tool.

In some embodiments, the claim data may include claims filed by customers against transactions processed by the plurality of merchant banks. In some embodiments, the claim data may also include one or more claims predicted to be filed against transactions processed by the plurality of merchant banks. In these embodiments, the merchant bank tool may use one or more claims-specific quantitative models and/or algorithms to forecast a number of claims statistically likely to be filed against the plurality of transactions processed by the merchant banks within time periods allowed by the regulatory rules governing the transaction channel(s) included in the transactional data. This prediction may be based on claim and transaction history data, in addition to the relevant channel's outstanding claimable transactions within a noted regulatory framework.

The predictive algorithms may exclude from their predictive analysis some percentages of one or more subsets of the transactional data. An exemplary subset of transactions that may be excluded from the predictive algorithm's analysis may include transactions for which a merchant has already issued a credit/refund and/or transactions for which the issuance of a credit/refund is pending. An additional exemplary subset of transactions includes transactions for customers who are not allowed to file claims with their issuing bank. Such customers may be barred from filing claims with their issuing bank due to a high risk factor, prior friendly fraudster behavior, i.e., when a customer issues a chargeback through his issuing bank falsely claiming that he never received the goods/services purchased, and/or previous bad faith interactions with the issuing bank.

The merchant bank tool may calculate an error value and an uncertainty value for the claims predicted to be filed against transactions processed by the plurality of merchant banks. This data may assist in determining a maximum and/or minimum risk that a merchant bank can potentially pose to an issuing bank.

### Disputed Merchant Data

The disputed merchant data received by the merchant bank tool may include one or more disputed merchant counts. A disputed merchant count may be a number of disputed merchants that used a merchant bank to process their transactions during the predetermined time period. The disputed merchant data may be received for each of the plurality of merchant banks. In some embodiments, disputed merchant data may include merchant data, such as a merchant identifier, that identifies some or all of the merchants that were identified as disputed merchants.

A claim rate calculator may be used to identify disputed merchants. The claim rate calculator may identify the disputed merchants by calculating a merchant's fraudulent claim ratio and/or a benchmarked merchant fraudulent claim ratio for a plurality of merchants. The claim ratios may be calculated as follows.

The claim rate calculator may first calculate a merchant claim ratio. The merchant claim ratio may be indicative of a percentage of a merchant's transactions that have generated customer claims. The merchant claim ratio may be calculated at least in part using the equation: (sum of a number of claims filed against a merchant during a predetermined time period)/(sum of a total number of transactions executed by the merchant during a predetermined time period).

The predetermined time period may be a day, a week, a month, two months, one year, a time period during which the merchant has been in business and/or any other suitable time period. In some embodiments, the claim rate calculator may align the predetermined time period with each transaction channel's regulatory and/or payment association maximum claim timeframe. An exemplary predetermined time period for a ratio including a debit card transaction channel and/or a credit card transaction channel may be 60 days, 90 days, 91 days or up to one year. An exemplary predetermined time period for a ratio including an ACH transaction channel may be up to one year.

The claims included in the numerator of the merchant claim ratio may be claims actually filed against transactions included in the denominator of the merchant claim ratio (referred to alternately hereinafter as “the transaction set”). These claims may be claims filed during the predetermined time period. Alternately, in the event that there is a time lapse between the end of the predetermined time period and the calculation of the merchant claim ratio, these claims may include any claims, filed against the transactions set, up until the initiation of the calculation of the merchant claim ratio.

The claims included in the numerator of the merchant claim ratio may also include claims predicted to be filed against the transaction set. In these embodiments, the claim rate calculator may use one or more claims-specific quantitative models and/or algorithms to forecast a number of claims statistically likely to be filed against the transaction set within the time periods allowed by the regulatory rules governing the transaction channel(s) included in the transaction set. This prediction may be based on claim and transaction history data, in addition to the relevant channel's outstanding claimable transactions within a noted regulatory framework.

The predictive algorithms may exclude from the transaction set all or some large percentages of one or more subsets of transactions. An exemplary subset of transactions that may be excluded from the predictive algorithm's analysis may include transactions for which a merchant has already issued a credit/refund and/or transactions for which the issuance of a credit/refund is pending. An additional exemplary subset of transactions includes transactions for customers who are not allowed to file claims with their issuing bank. Such customers may be barred from filing claims with their issuing bank due to a high risk factor, prior friendly fraudster behavior, i.e., when a customer issues a chargeback through his issuing bank falsely claiming that he never received the goods/services purchased, and/or previous bad faith interactions with the issuing bank.

In some of these embodiments, the claim rate calculator may calculate an error value and an uncertainty value for a merchant claim ratio calculated using claims predicted to be filed against the merchant. This data may assist in determining a maximum risk that a merchant can potentially pose to a merchant bank and/or an issuing bank.

The claim rate calculator may then benchmark the merchant claim ratio. The benchmarked merchant claim ratio may be indicative of a merchant's claim rate relative to an industry's claim rate. The benchmarked merchant claim ratio may be calculated at least in part using the equation: (merchant claim ratio)/(industry claim ratio).

An exemplary industry claim ratio used to benchmark a merchant claim ratio may be calculated at least in part using the equation: (a sum of a total number of claims filed against merchants in an industry)/(a sum of a total number of transactions executed by the merchants in the industry during a predetermined time period). It should be noted that the industry data may be data associated with the same transaction channel(s) as the merchant claim ratio being benchmarked.

Industry data used to benchmark a merchant claim ratio may be data from one or more merchants associated with the same industry as the merchant whose data is being benchmarked. For example, the claim rate calculator may retrieve data from industry database(s) that corresponds to merchant transaction data for merchants with the same MCC or industry code as the merchant.

An industry code may relate to a four or six digit code defined by a governmental body and used to classify industries. Additionally, it should be noted that a MCC may be a code assigned to a business directly by MasterCard™ or Visa™ that classifies businesses by the type of goods and/or services that the business provides. Alternately, the MCC may be a code assigned to a business by a merchant or their merchant bank. However, it should be noted that such an assignment is equivalent to an indirect assignment by MasterCard™ or Visa™, since the merchant and the merchant bank are required to comply with MasterCard™ or Visa™ MCC selection standards.

In other embodiments, the claim rate calculator may consider one or more parameters other than industry type in order to group merchants for comparison to each other. For example, the claim rate calculator may define a peer group of merchants that materially compete with each other (also known as a ‘competitor set’) and use merchant transaction data from the defined peer group for benchmarking calculations. It should be noted that the merchants in the peer group may be merchants associated with a single industry or merchants across multiple industries.

The merchant fraudulent claim ratio calculated by the claim rate calculator may be indicative of a percentage of merchant transactions which have given rise to fraudulent claims against the merchant. In some embodiments, the merchant fraudulent claim ratio may be calculated at least in part using the equation: (sum of a total number of fraudulent claims filed against a merchant)/(sum of a total number of claims filed against the merchant).

The merchant fraudulent claim ratio may alternately be calculated at least in part using the equation: (sum of a total number of fraudulent claims filed against a merchant during a predetermined time period)/(sum of a total number of non-fraudulent claims filed against the merchant during the predetermined time period). Additionally, the merchant fraudulent claim ratio may be calculated at least in part using the equation: (sum of a total number of fraudulent claims filed against a merchant)/(sum of a total number of transactions executed by the merchant during the predetermined time period). It should be noted that the merchant fraudulent claim ratio may be calculated using transaction data associated with one or more transaction channels.

The fraudulent claims, non-fraudulent claims and total claims included in the merchant fraudulent claim ratio may be claims filed against a merchant during a predetermined time period. Alternately, the fraudulent claims, non-fraudulent claims and total claims may be claims actually filed and, in some embodiments, predicted to be filed against transactions included in a transaction set. The transaction set may include transactions generated by the merchant during a predetermined time period.

The claim rate calculator may determine if a claim is ‘fraudulent’ by analyzing stored data associated with the claim. In some embodiments, the claim rate calculator may determine if a claim is ‘fraudulent’ by searching a stored description of the claim for the word ‘fraud,’ a word that includes the letters ‘f-r-a-u-d’ and/or by searching the stored description for other words such as, for example, ‘deception,’ ‘scam,’ ‘con,’ ‘scheme,’ ‘swindle,’ ‘hoax,’ and/or ‘deceit.’ An example of a type of claim where a customer may use the word ‘fraud’ is a claim based on a merchant's unauthorized credit card transaction.

Alternately, the claim rate calculator may determine if a claim is ‘fraudulent’ based on a stored item type code associated with the claim. The item type code may be a code automatically or manually assigned to a claim during initial claim entry.

It should be noted that the claim rate calculator may apply some or all of the calculations described herein to chargeback information in place of claim information. In these embodiments, the claim rate calculator may use a reason code associated with a chargeback to determine if the chargeback is based on fraudulent merchant behavior or non-fraudulent merchant behavior. The reason code may be a code selected by personnel in a bank office of an issuing bank when initially processing a claim filed by the issuing bank's customer. For example, a chargeback with a reason code relating to fraudulent merchant behavior may be determined to be a ‘fraudulent’ chargeback by the systems and methods of the invention.

The claim rate calculator may benchmark the merchant fraudulent claim ratio. The benchmarked merchant fraudulent claim ratio may be indicative of a merchant's fraudulent claim ratio relative to an industry's fraudulent claim ratio. In some embodiments, the benchmarked merchant fraudulent claim ratio may be calculated at least in part using the following equation: (merchant fraudulent claim ratio)/(industry fraudulent claim ratio).

The industry fraudulent claim ratio may be calculated at least in part using the equation: (sum of a total number of fraudulent claims filed against merchants in an industry)/(sum of a total number of transactions executed by the merchants in the industry during a predetermined time period). Industry data used to benchmark a merchant fraudulent claim ratio may be data obtained from merchants associated with the same industry and/or merchants from the same peer group as the merchant being analyzed. It should be noted that the industry data may include data associated with one or more transaction channels. It should be noted that the industry data may be data associated with the same transaction channel(s) as the merchant fraudulent claim ratio being benchmarked.

The claim rate calculator may additionally include a claim rate database. The claim rate database may include stored data relating to a threshold value claim rate for one or more of the ratios calculated by the invention. The claim rate database may additionally include stored data relating to a threshold value for the increase of one or more ratios calculated by the invention.

The threshold values may be the same for all merchants. In other embodiments, the threshold values may differ between one or more merchants based on an industry and/or peer group that the merchant is affiliated with. In yet other embodiments, the threshold value may be adjusted based on merchant-specific data, such as how long a merchant has been in business and/or the volume/worth of the merchant's transactions to the merchant bank and/or issuer bank. This may be desirable because a merchant with a high volume of transactions may expose a merchant bank and/or an issuer bank to greater risk than a merchant with a low volume of transactions.

The claim rate calculator may calculate one or more of the aforementioned ratios for one or more merchants upon the lapse of a time interval. The time interval may be a day, a week, two weeks, a month, a time interval that aligns with a transaction channel's regulatory requirements and/or any other suitable time interval. Each of the ratios may be calculated upon the lapse of the same time interval or upon the lapse of different time intervals.

The claim rate calculator may save the ratios calculated for one or more merchants in a database. The claim rate calculator may subsequently compare the calculated ratios, in addition to rate(s) of increase or decrease of the calculated ratios, against the threshold values stored in the claim rate database. In the event that a merchant's claim rate or a rate of increase of a claim rate exceeds the respective threshold value by a quantitatively justified deviation, the claim rate calculator may implement one or more remedial measures. In some embodiments, the difference between the calculated claim rate and the threshold value claim rate may determine which, if any, remedial measures to implement.

The claim rate calculator may output data to the merchant bank tool that includes a list of disputed merchants (i.e., merchants for which one or more of a merchant claim ratio, benchmarked merchant claim ratio, merchant fraudulent claim ratio and/or benchmarked merchant fraudulent claim ratio that is greater than or equal to a threshold value claim rate).

In some embodiments, the claim rate calculator may output to the merchant bank tool a disputed merchant count—i.e., for each of a plurality of merchant banks, how many disputed merchants each merchant bank did business with during the predetermined time period. In some embodiments, the claim rate calculator may output to the merchant tool merchant data, such as merchant identifiers, that identify some or all of the disputed merchants.

In some embodiments, the merchant bank tool may compute a disputed merchant count for each of the plurality of merchants based on data received from the claim rate calculator.

In some embodiments, a disputed merchant in accordance with the invention the invention may be identified by the claim rate calculator using additional information. For example, the claim rate calculator may be configured to execute bad actor merchant due diligence (referred to alternately hereinafter as ‘BAM’) to identify disputed merchants.

The claim rate calculator may execute BAM by searching for information corresponding to the merchant and/or the merchant's principles. Exemplary merchant principles include the merchant's CEO, board of directors, and management. In some embodiments, the claim rate calculator may additionally identify a network affiliated with the merchant and search for information relating to those included in the merchant's network. The network may include companies, businesses, and associations affiliated with the merchant, part of a multi-level marketing group associated with the merchant and/or part of a chain of multiple industries throughout the country that include the merchant. The network may additionally include the principles associated with these companies, businesses and associations.

After identification of the merchant(s) and/or principle(s) associated with the merchant and/or the merchant network, the claim rate calculator may search multiple databases to retrieve information indicative of the merchant(s) and/or principle(s) ethics. Exemplary information indicative of ethics may include information relating to illegal/unethical practices, association violations, negative press reports, lawsuits and/or being categorized as being ‘high risk’ by one or more third parties.

The multiple databases searched may be within one or more transaction channels. The databases may also be cross-industry databases. Cross-industry databases include databases maintained by banks, non-bank financial services, retailers, business & consumer credit bureaus and legal databases. Exemplary databases that may be used by the claim rate calculator include LexisNexis™ databases, high risk merchant categories generated by Visa™/MC™/Amex™ and any other lists in the industry that identify industries from which an acquirer will generally not on-board a merchant.

The claim rate calculator may process the data accessed during BAM. The processing may include assigning a risk score to the merchant. The risk score may score a level of risk associated with the merchant based on the data obtained.

The risk score may take into account the impact of the information retrieved during BAM on a merchant's ethics. For example, certain pieces of information may not be indicative of a merchant's ethics, such as a small lawsuit between the merchant's principle and a neighbor. Additionally, a cease and desist letter may not be entirely determinative of a merchant's ethics if the case has not yet been litigated or settled.

The risk score may also take into account additional information relevant to a risk inherent in a merchant-bank relationship. Exemplary additional information includes whether there is a TPA/Agent Bank between the merchant bank and the merchant. Other exemplary additional information includes the nature of the relationship between the merchant and the bank. For example, in the event that the bank is the issuing bank, the risk score may take into account a projected net income that the bank will forfeit if it terminates the merchant-bank relationship.

BAM may also include categorizing a merchant as a ‘bad actor’ based on unacceptable merchant claim ratios, data accessed while searching the cross-industry databases and/or a merchant a risk score. It should be noted that a merchant determined to be a ‘bad actor’ in one transaction channel may be categorized as a ‘bad actor’ for all transaction channels.

In some of these embodiments, information retrieved during BAM may be used by the claim rate calculator to classify merchants as disputed merchants. In some embodiments, this information may be used in addition to the merchant claim ratios (i.e., a merchant claim ratio, a benchmarked merchant claim ratio, a merchant fraudulent claim ratio and/or a benchmarked merchant fraudulent claim ratio) detailed above.

### Calculation of Metric Values and a Final Risk Score

The merchant bank tool may use the claim data, transactional data and/or disputed merchant data to calculate, for each of a plurality of merchant banks, a metric value for each of one or more metrics. The merchant bank tool may subsequently use the metric values calculated for each merchant bank to assign a final risk score to the merchant bank.

The merchant bank tool may calculate metric values for a single metric or a plurality of metrics. Exemplary metrics include one or more of the five metrics detailed below. In some embodiments, one or more other suitable metrics may also be calculated.

The first metric may be a Total Incoming Claims metric. A metric value calculated for the Total Incoming Claims metric may relate to a total number of claims filed against transactions processed by a merchant bank during the predetermined time period.

The second metric may be a Trend of Disputed Claims metric. A metric value calculated for the Trend of Disputed Claims metric may relate to an average rate of change of claims filed against transactions processed by a merchant bank during the predetermined time period. The average rate of change may be calculated by dividing the predetermined time period into two or more time periods, and calculating the change in the rate of claims filed between the two or more time periods. In some embodiments, a metric value for the Trend of Disputed Claims metric may be calculated using the equation

$$( {\sum }_{t = 0}^{n} \frac{( y ( t + 1 ) - y ( t ) )}{x ( t + 1 ) - x ( t )} ) / ( n + 1 )$$

where y(t) is a number of claims filed against transactions processed by a merchant bank during at time t, x(t) is a unit of time at time t, and (n+1) is a total number of time periods.

For example, the predetermined time period may be twenty-six weeks. The predetermined time period may be divided into twenty-six segments of seven days each. The average rate of change may be calculated by determining a total number of claims filed in each of the twenty-six weeks, calculating a change in claims filed from week to week, and then summing the calculated change in claims and dividing it by twenty-six.

The third metric may be a Total Transaction Volume metric. A metric value calculated for the Total Transaction Volume metric may relate to a total number of transactions processed by a merchant bank during the predetermined time period.

The fourth metric may be a Number of Disputed Merchants metric. A metric value calculated for the Number of Disputed Merchants metric may relate to a total number of disputed merchants engaged in business with a merchant bank during the predetermined time period. The disputed merchants may be disputed merchants identified by the claim rate calculator.

The fifth metric be a Merchant Bank Claim Rate metric. A metric value calculated for the Merchant Bank Claim Rate metric may be calculated by the following equation: (a metric value calculated, for a merchant bank, for metric 1)/(a metric value calculated, for the merchant bank, for metric 3).

One or more of the five metrics may be used by the merchant bank tool to calculate a final risk score for each of the plurality of merchant banks. The merchant bank tool may calculate the final risk score using the calculations detailed below.

The merchant bank tool may profile, for each metric, a distribution of the metric values calculated for the metric. The metric values used in the distribution may include metric values calculated for the plurality of merchant banks.

In some embodiments, the plurality of merchant banks may be merchant banks included in a merchant bank peer group. The merchant bank peer group may include merchant banks with one or more similar characteristics. Exemplary similar characteristics include merchant banks located in the same state, merchant banks located within a predetermined geographical area and/or merchant banks that have been in business for a predetermined number of years.

The merchant bank tool may bin each metric's distribution into two or more bins. The distribution may be binned using a ranking algorithm. Each bin may be assigned a risk score.

A profiling of a metric distribution is detailed in Table 1 below. In Table 1, the metric values of an exemplary metric have been divided into ten bins. Additionally, a risk score has been assigned to each bin.

TABLE 1

| Bins for Total | Risk |
|---|---|
| Incoming Claims Metric | Score (Sᵢ) |
| 0-499 | 0 |
| 500-999 | 1 |
| 1000-1499 | 2 |
| 1500-1999 | 3 |
| 2000-2499 | 4 |
| 2500-2999 | 5 |
| 3000-3499 | 6 |
| 3500-3999 | 7 |
| 4000-4499 | 8 |
| 4500-4999 | 9 |
| [symbol] 5000 | 10 |

In the exemplary profiled metric distribution illustrated at Table 1 above, a merchant bank with a Total Incoming Claims metric value of 2300 will be assigned a risk score 4.

The merchant bank tool may determine, for each merchant bank and for each metric, which bin the merchant bank's metric value is included in. The merchant bank tool may then assign to the merchant bank the risk score associated with the bin that the merchant bank's metric value is included in.

The merchant bank tool may assign to each metric a weighted value. A sum of each of the weighed values assigned to each of the plurality of metrics may be equal to one (Σᵢ₌₁ⁿWi=1). In the embodiments in which the claim rate calculator calculates metric values for five metrics, n will be equal to 5.

A weight assigned to a metric may be based at least in part on how probative the metric is in determining an issuing bank's risk in maintaining a relationship with a merchant bank. For example, the Trend of Disputed Claims metric may be assigned a large weight value because a trend of increase or decrease in a number of claims filed against transactions processed by a merchant bank may be relatively highly probative in determining a risk involved in maintaining a relationship with the merchant bank.

The merchant bank tool may multiply each risk score by a weighted value. Specifically, a risk score assigned to a merchant bank for metric i may be multiplied by a weighted value assigned to the metric i. For example, a merchant bank's risk score calculated for metric 1 may be multiplied by the weighted value assigned to metric 1.

The merchant bank tool may sum the weighted risk scores calculated for each merchant bank. The sum of a merchant banks' weighted risk scores may be a merchant bank's final risk score. In some embodiments, the final risk score may be calculated using the equation: Σᵢ₌₁⁵Wi*Si, where S, is a risk score for the i^{th} metric and W, is a weighted value for the i^{th} metric.

A final risk score may be calculated for some or all of the plurality of merchant banks. The final risk score may also be referred to as an “aggregated risk score.” The merchant bank tool may rank the final risk scores in descending or ascending order. The ranked final risk scores may be used to identify a level of risk associated with each of the merchant banks.

In some embodiments, all ranked merchant banks may be electronically classified as disputed merchant banks. In some embodiments, merchant banks with a risk score equal to or greater than a predetermined threshold may be electronically classified as disputed merchant banks. In some embodiments, merchant banks with risks scores that fall within a top predetermined number of risk scores may be electronically classified as disputed merchant banks. For example, the merchant banks with the top ten risk scores may be electronically indexed as disputed merchant banks. A merchant bank may be electronically classified as a disputed merchant bank by storing data in a database, indexing merchant bank data, associating an electronic tag with merchant bank data and/or using any other suitable technique.

The invention may include one or more forms of mitigation activity. The mitigation activity may be electronically initiated after the classification of a merchant bank as a disputed merchant bank. Exemplary mitigation activity that may be electronically initiated for each disputed merchant bank may include electronically generating and transmitting a correspondence to a disputed merchant bank. The correspondence may include data identifying one or more disputed merchants that use the merchant bank to process transactions on their behalf. In some embodiments, the correspondence may be an e-mail. In some embodiments, the correspondence may detail remedial action that must be taken by a merchant bank in order to sustain a business relationship with an issuing bank.

Greater mitigation priority may be assigned to merchant banks with an absolute final risk score value that is high relative to other calculated absolute value final risk scores. In some embodiments, mitigation priority may be based at least in part on a final risk score of a merchant bank.

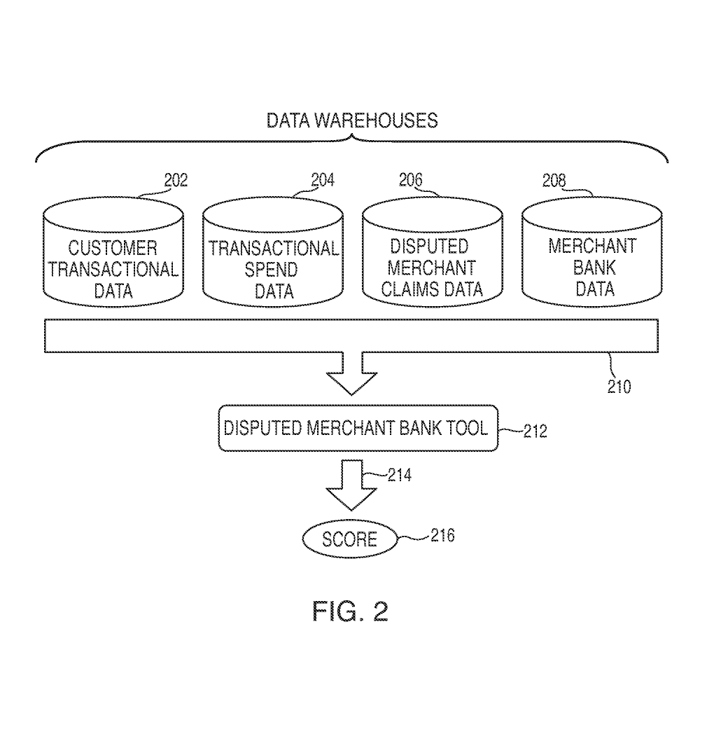

Each of the metric values calculated for one of the five metrics may be charted and displayed on a graphical user interface (“GUI”). Alternatively, some of the metric values calculated for a metric may be charted and displayed on a GUI. An electronic data file containing one or more of the charts may be electronically transmitted to one or more e-mail addresses. Exemplary charts output by the merchant bank tool are illustrated in FIGS. 2-8, which are described in greater detail below.

The merchant bank tool may calculate a final risk score for a plurality of merchant banks upon a lapse of a time interval. The time interval may be a day, a week, two weeks, a month, a time interval that aligns with a transaction channel's regulatory requirements and/or any other suitable time interval. Each of the final risk scores for one or more transaction channels may be calculated upon the lapse of the same time interval or upon the lapse of different time intervals.

Illustrative embodiments of apparatus and methods in accordance with the principles of the invention will now be described with reference to the accompanying drawings, which form a part hereof. It is to be understood that other embodiments may be utilized and structural, functional and procedural modifications may be made without departing from the scope and spirit of the present invention.

As will be appreciated by one of skill in the art upon reading the following disclosure, the merchant bank tool and/or the claim rate calculator may be embodied as a method, a data processing system, or a computer program product. Accordingly, the merchant bank tool and/or the claim rate calculator may take the form of an entirely hardware embodiment, an entirely software embodiment or an embodiment combining software and hardware aspects.

Furthermore, the merchant bank tool and/or the claim rate calculator may take the form of a computer program product stored by one or more computer-readable storage media having computer-readable program code, or instructions, embodied in or on the storage media. Any suitable computer readable storage media may be utilized, including hard disks, CD-ROMs, optical storage devices, magnetic storage devices, and/or any combination thereof. In addition, various signals representing data or events as described herein may be transferred between a source and a destination in the form of electromagnetic waves traveling through signal-conducting media such as metal wires, optical fibers, and/or wireless transmission media (e.g., air and/or space).

In an exemplary embodiment, the merchant bank tool and/or the claim rate calculator may be embodied at least partially in hardware and include one or more databases, receivers, transmitters, processors, modules including hardware and/or any other suitable hardware. Furthermore, operations executed by the merchant bank tool and/or the claim rate calculator may be performed by the one or more databases, receivers, transmitters, processors and/or modules including hardware.

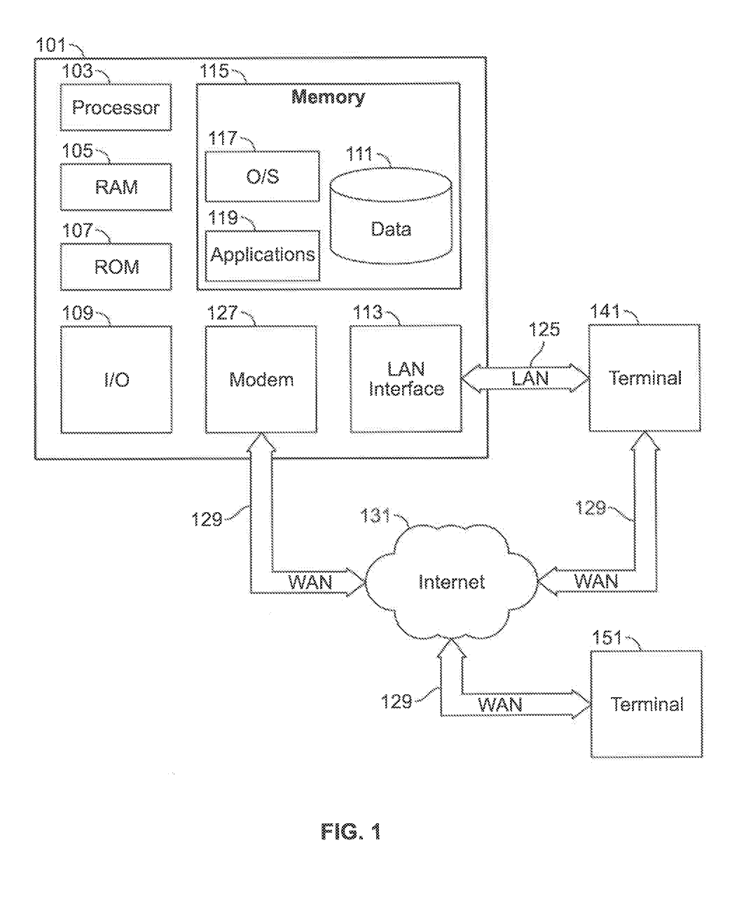

FIG. 1 is a block diagram that illustrates a generic computing device 101 (alternately referred to herein as a “server”) that may be used according to an illustrative embodiment of the invention. The computer server 101 may have a processor 103 for controlling overall operation of the server and its associated components, including RAM 105, ROM 107, input/output module 109, and memory 115.

Input/output (“I/O”) module 109 may include a microphone, keypad, touch screen, and/or stylus through which a user of server 101 may provide input, and may also include one or more of a speaker for providing audio output and a video display device for providing textual, audiovisual and/or graphical output. Software may be stored within memory 115 and/or storage to provide instructions to processor 103 for enabling server 101 to perform various functions. For example, memory 115 may store software used by server 101, such as an operating system 117, application programs 119, and an associated database 111. Alternately, some or all of server 101 computer executable instructions may be embodied in hardware or firmware (not shown). As described in detail below, database 111 may provide storage for information input into the merchant bank tool and/or the claim rate calculator.

Server 101 may operate in a networked environment supporting connections to one or more remote computers, such as terminals 141 and 151. Terminals 141 and 151 may be personal computers or servers that include many or all of the elements described above relative to server 101. The network connections depicted in FIG. 1 include a local area network (LAN) 125 and a wide area network (WAN) 129, but may also include other networks. When used in a LAN networking environment, computer 101 is connected to LAN 125 through a network interface or adapter 113. When used in a WAN networking environment, server 101 may include a modem 127 or other means for establishing communications over WAN 129, such as Internet 131. It will be appreciated that the network connections shown are illustrative and other means of establishing a communications link between the computers may be used. The existence of any of various well-known protocols such as TCP/IP, Ethernet, FTP, HTTP and the like is presumed, and the system can be operated in a client-server configuration to permit a user to retrieve web pages via the World Wide Web from a web-based server. Any of various conventional web browsers can be used to display and manipulate data on web pages.

Additionally, application program 119, which may be used by server 101, may include computer executable instructions for invoking user functionality related to communication, such as email, short message service (SMS), and voice input and speech recognition applications.

Computing device 101 and/or terminals 141 or 151 may also be mobile terminals including various other components, such as a battery, speaker, and antennas (not shown).

A terminal such as 141 or 151 may be used by a user of the merchant bank tool and/or the claim rate calculator to access and input information into the merchant bank tool and/or the claim rate calculator. Information input into the merchant bank tool may be stored in memory 115. In some embodiments, information input into the claim rate calculator may be stored in memory 115. The input information may be processed by an application such as one of applications 119.

FIG. 2 shows a flow diagram of exemplary apparatus and an exemplary process in accordance with the invention. The exemplary apparatus may include four data warehouses. The data warehouses may include customer transactional data warehouse 202, transactional spend data warehouse 204, disputed merchant claims data warehouse 206 and merchant bank data warehouse 208.

Transactional data warehouse 202 may store payment information. Payment information may include information relating to a plurality of payments, such as debit card transactions, credit card transactions, and/or ACH transactions. The payments may be payments executed by one or more merchants. The payment information may additionally include payment processing information. The payment processing information may relate to the processing of payments by one or more third party agents information and/or one or more merchant banks.

Spend data warehouse 204 may store transaction information. Transaction information may include information relating to one or more features of payment transactions executed by one or more merchants. Exemplary features of payment transactions include whether each payment transactions was an online/offline transaction, the amount of the payment transaction, the date of the transaction, customer information identifying an account number of a customer who executed the payment transaction and/or an MCC assigned to the transaction.

Disputed merchant claim data warehouse 206 may store claim level information. Claim level information may include information detailing one or more characteristics of customer claims filed against transactions executed by one or more merchants and processed by merchant banks. Exemplary claim level information may include whether a claim is a fraud-based claim or a non-fraud claim, the date the claim was filed, the amount of the claim and/or the current status of the claim.

Merchant bank data warehouse 208 may store information relating to one or more merchant banks. Merchant bank information may include, for one or more merchants banks, the name of the merchant banks, an acceptor ID associated with each merchant bank and/or the address of the merchant banks.

The exemplary apparatus may also include disputed merchant bank tool 212. The data warehouses, and disputed merchant bank tool 212, may include one or more of the apparatus detailed at FIG. 1 above.

At step 210, data stored in the data warehouses may be transmitted to the disputed merchant bank tool 212. Disputed merchant bank tool 212 may use the data to calculate metric values for the five metrics detailed above. At step 214, disputed merchant bank tool 212 may output score 216. Score 216 may be a final risk score calculated for each of a plurality of merchants.

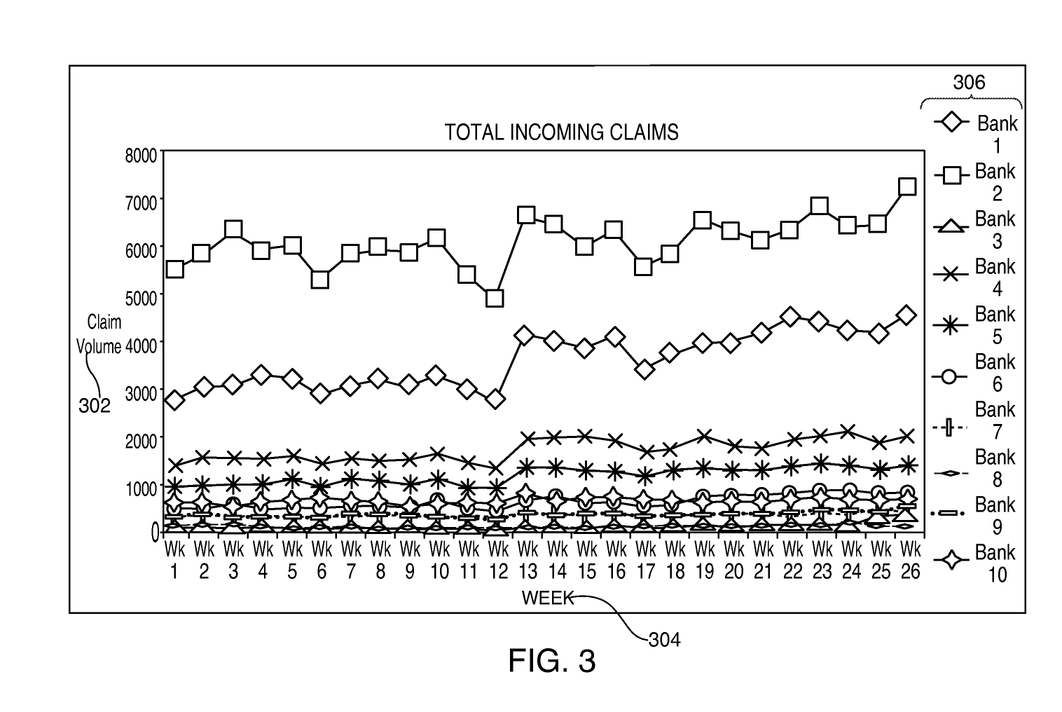

FIG. 3 shows a graphical display that may be output by the merchant bank tool. The graphical display illustrated in FIG. 3 may graph claim volume 302 for each week 304. Claim volume 302 may represent a number of claims filed against transactions processed by each of merchant banks 306 during each of weeks 304.

FIG. 3 may be an exemplary graph illustrating values used by the merchant bank tool to calculate metric values for the Total Incoming Claims metric. For example, for merchant bank 1, the merchant bank tool may sum merchant bank 1's claim volume 302 for each week 304 to arrive at merchant bank 1's metric value for the Total Incoming Claims metric. In these embodiments, the Total Incoming Claims metric value may be a total number of claims filed against merchant bank 1 during a twenty-six week period.

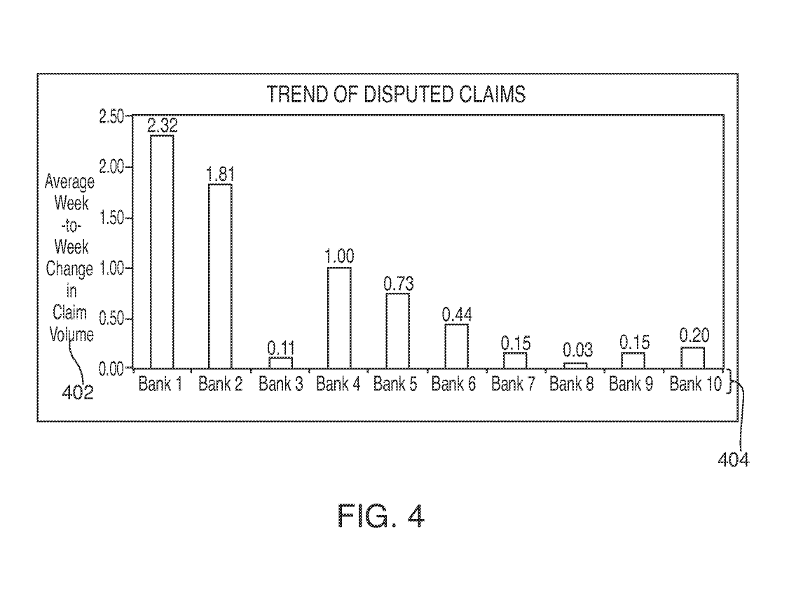

FIG. 4 shows another graphical display that may be output by the merchant bank tool. The graphical display illustrated in FIG. 4 may graph average week-to-week change in claim volume 404 for each of merchant banks 404. Merchant banks 404 may include merchant banks 1-10. In some embodiments, average week-to-week change in claim volume 404 may be an average week-to-week change in claim volume 302 between weeks 304 graphed at FIG. 3 above.

FIG. 4 may illustrate metric values calculated for the Trend of Disputed Claims metric. The metric values may be metric values calculated for merchant banks 1-10.

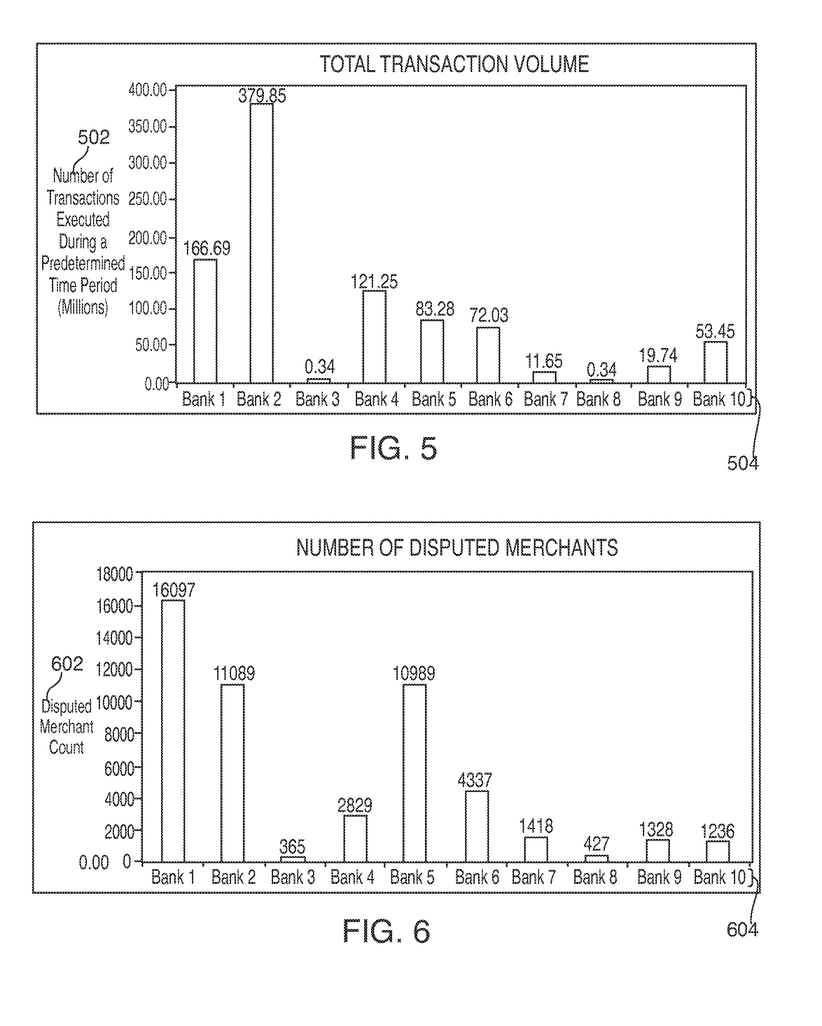

FIG. 5 shows yet another graphical display that may be output by the merchant bank tool. The graphical display illustrated in FIG. 5 may graph number of transactions executed during a predetermined time period 502 for each of merchant banks 504. In some embodiments, the predetermined time period may be a twenty-six week time period.

FIG. 5 may illustrate metric values calculated for the Total Transaction Volume metric. The metric values may be metric values calculated for merchant banks 1-10.

FIG. 6 shows yet another graphical display that may be output by the merchant bank tool. The graphical display illustrated in FIG. 6 may graph disputed merchant count 602 for each of merchant banks 604. Disputed merchant count 602 may be a total number of disputed merchants engaged in business with a merchant bank during a predetermined time i.e. merchants who used a merchant bank to process one or more of their transactions during a predetermined time period. In some embodiments, the predetermined time period may be a twenty-six week time period.

FIG. 6 may illustrate metric values calculated for the Number of Disputed Merchants metric. The metric values may be metric values calculated for merchant banks 1-10.

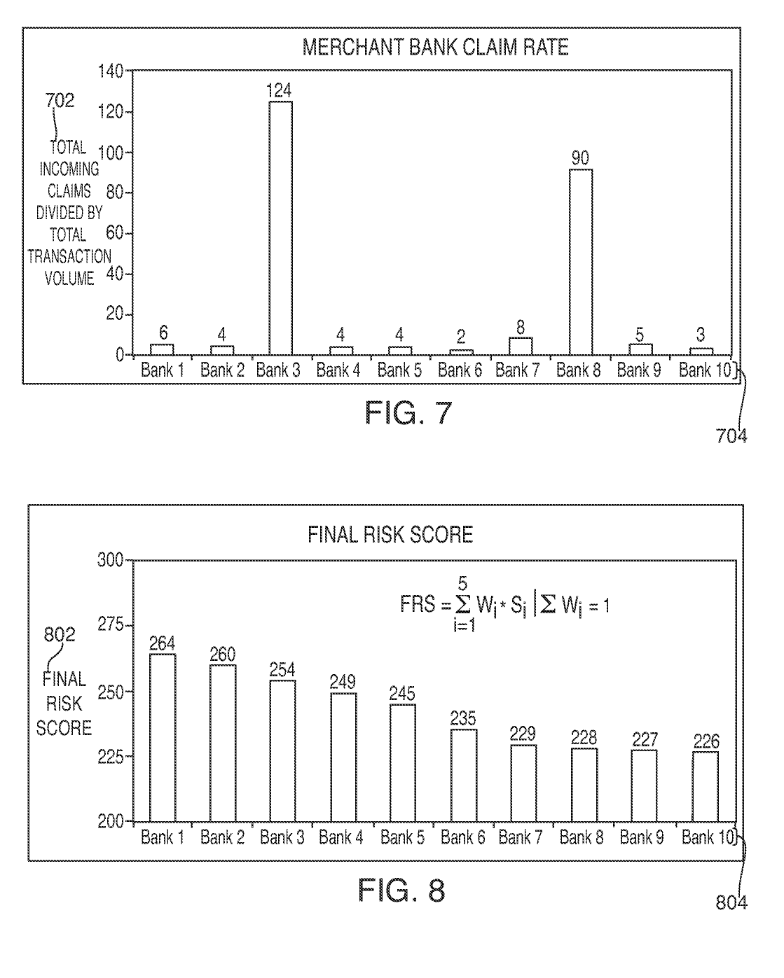

FIG. 7 shows yet another graphical display that may be output by the merchant bank tool. The graphical display illustrated in FIG. 7 may graph total incoming claims divided by total transaction volume 702 for each of merchant banks 704. In some embodiments the total incoming claims may be, for each merchant bank, a sum of a claim volumes 302 illustrated in FIG. 3 for all of weeks 304. In some embodiments, the total transaction volume may be, for each merchant bank, a number of transactions executed during predetermined time period 502.

FIG. 7 may illustrate metric values calculated for the Merchant Bank Claim Rate metric. The metric values may be metric values calculated for merchant banks 1-10.

FIG. 8 shows yet another graphical display that may be output by the merchant bank tool. The graphical display illustrated in FIG. 8 may graph final risk score 802 for merchant banks 804.

FIG. 8 may illustrate final risk scores 802 calculated by the merchant bank tool for each of merchant banks 1-10 as detailed above.

Thus, methods and apparatus for processing merchant bank data have been provided. Persons skilled in the art will appreciate that the present invention can be practiced in embodiments other than the described embodiments, which are presented for purposes of illustration rather than of limitation, and that the present invention is limited only by the claims that follow.

1. An article of manufacture comprising a non-transitory computer usable medium having computer readable program code embodied therein, the code when executed by a processor causes a computer to compute metric values for merchant banks, the computer readable program code in said article comprising:
computer readable program code for causing the computer to receive:
transactional data including a plurality of transactions processed by merchant banks during a predetermined time period, wherein a merchant bank processes credit card payments on behalf of a merchant and transmits a request for funds to a transaction processing network;
claim data including a plurality of claims filed against one or more of the plurality of transactions; and
disputed merchant data including one or more identifiers identifying disputed merchants, the disputed merchants being merchants with a benchmarked claim rate that has surpassed a predetermined threshold, wherein:
the claim rate is calculated based on a merchant claim ratio comprising merchant transactions that have generated claims divided by a total number of merchant transactions;
the claim rate is benchmarked by dividing the merchant claim ratio by an industry claim ratio, prior to comparison to the predetermined threshold; and
the predetermined threshold is adjustable based on merchant-specific data comprising a volume of merchant transactions or a worth of merchant transactions to the issuing bank;
computer readable program code for causing the computer to identify a plurality of merchant banks, each of the plurality of merchant banks being a merchant bank that electronically processed one or more transactions on behalf of one or more disputed merchants during the predetermined time period;
computer readable program code for causing the computer to calculate, for each merchant bank that electronically processed a transaction on behalf of a disputed merchant, separate metric values for each of a plurality of metrics, based at least in part on the transactional data, the claim data and the disputed merchant data;
computer readable program code for causing the computer, for each metric, to sort a plurality of metric values, comprising the metric values calculated for each merchant bank that processed a transaction an behalf of a disputed merchant, into a plurality of bins, each bin comprising a predetermined range of metric values and corresponding to a predetermined merchant bank risk score for the metric;
computer readable program code for causing the computer to determine whether each merchant bank that electronically processed a transaction on behalf of a disputed merchant is a disputed merchant bank, the determination being based on merchant bank risk scores for each of the plurality of metrics; and
computer readable program code for causing the computer to provide mitigation options for a merchant bank determined to be a disputed merchant bank.

2. The article of manufacture of claim 1 further comprising computer readable program code for causing the computer to calculate an aggregated risk score for each merchant bank.

3. The article of manufacture of claim 2 wherein the aggregated risk score for each merchant bank is calculated by summing a risk score for each metric value associated with the merchant bank, the risk score corresponding to the risk score of the bin into which the metric value is sorted.

4. The article of manufacture of claim 3 further comprising computer readable program code for causing the computer to calculate the aggregated risk score based on the equation Σᵢ₌₁ⁿSᵢ*wᵢ, where i is one of the plurality of metrics, Sᵢ is a risk score assigned to a merchant for metric i, and wᵢ is a weight value associated with metric i.

5. The article of manufacture of claim 1 wherein the computer readable program code causes the computer to calculate a metric value for a merchant bank by accessing and summing a total number of claims filed against transactions processed by the merchant bank during the predetermined time period.

6. The article of manufacture of claim 1 wherein the computer readable program code causes the computer to calculate a metric value for a merchant bank by calculating an average change in an amount of claims filed against transactions processed by the merchant bank during the predetermined time period.

7. The article of manufacture of claim 1 wherein the computer readable program code causes the computer to calculate a metric value for a merchant bank by dividing a total number of claims filed against transactions processed by the merchant bank during the predetermined time period by a total number of transactions processed by the merchant bank during the predetermined time period.

8. The article of manufacture of claim 1 wherein the computer readable program code causes the computer to electronically transmit an email message to at least a portion of the plurality of merchant banks, the email message detailing remedial action that must be taken by the merchant bank in order to sustain a business relationship with an issuing bank.

9. Apparatus for computing metric values for merchant banks, the apparatus comprising:
a hardware receiver configured to receive:
transactional data including a plurality of transactions processed by merchant banks during a predetermined time period;
claim data including a plurality of claims filed against one or more of the plurality of transactions; and
disputed merchant data including one or more identifiers identifying disputed merchants, the disputed merchants being merchants with a benchmarked claim rate that has surpassed a predetermined threshold, wherein:
the claim rate is calculated based on a merchant claim ratio comprising merchant transactions that have generated claims against the merchant divided by a total number of merchant transactions
the claim rate id benchmarked by dividing the merchant claim ratio by an industry claim ratio, prior to comparison to the predetermined threshold; and
the predetermined threshold is adjustable based on merchant-specific data comprising a volume of merchant transactions or a worth of merchant transactions to the issuing bank;
a hardware processor configured to identify a plurality of merchant banks, each of the plurality of merchant banks being a merchant bank that electronically processed one or more transactions on behalf of one or more disputed merchants during the predetermined time period;
the processor being further configured to calculate, for each of the plurality of merchant banks, a metric value for each of a plurality of metrics based at least in part on the transactional data, the claim data and the disputed merchant data;
the processor being further configured, for each metric, to sort a plurality of metric values calculated for merchant banks that electronically processed one or more transactions on behalf of a disputed merchant, into a plurality of bins, wherein each bin comprises a predetermined range of metric values and corresponds to a predetermined merchant bank risk score for the metric;
the processor being further configured to determine whether each of the plurality of merchant banks is a disputed merchant bank, the determination being based on merchant bank risk scores for each of the plurality of metrics.

10. The apparatus of claim 9 wherein the processor is further configured to calculate an aggregated risk score for each merchant bank.

11. The apparatus of claim 10 wherein the processor is further configured to calculate the aggregated risk score for each merchant bank by summing a risk score for each metric value associated with the merchant bank, the risk score corresponding to the risk score of the bin into which the metric value is sorted.

12. The apparatus of claim 11 wherein the processor is further configured to calculate the aggregated risk score based on the equation Σᵢ₌₁ⁿSᵢ*wᵢ, where i is one of the plurality of metrics, Sᵢ is a risk score assigned to a merchant for metric i, and wᵢ is a weight value associated with metric i.

13. The apparatus of claim 9 wherein the processor is further configured to calculate a metric value for a merchant bank by accessing and summing a total number of claims filed against transactions processed by the merchant bank during the predetermined time period.

14. The apparatus of claim 9 wherein the processor is further configured to calculate a metric value for a merchant bank by calculating an average change in an amount of claims filed against transactions processed by the merchant bank during the predetermined time period.

15. The apparatus of claim 9 wherein the processor is further configured to calculate a metric value for a merchant bank by dividing a total number of claims filed against transactions processed by the merchant bank during the predetermined time period by a total number of transactions processed by the merchant bank during the predetermined time period.

16. The apparatus of claim 12 further comprising a transmitter configured to electronically transmit an email message to a portion of the plurality of merchant banks with a final risk score equal to or greater than a predetermined threshold value, the email message detailing remedial action that must be taken by the merchant bank in order to sustain a business relationship with an issuing bank.
